(19) United States
(12) Patent Application Publication
(10) Pub. No.: US 2007/0232720 A1
(43) Pub. Date: Oct. 4, 2007

(54) Extrusion Process

(76) Inventor: Graham John Whitchurch, Lincolnshire (GB)

Correspondence Address: LAW OFFICES OF WILLIAM H. HOLT, 12311 HARBOR DRIVE, WOODBRIDGE, VA, 22192, US

(21) Appl. No.: 11/596,291

(22) PCT Filed: May 11, 2005
(86) PCT No.: PCT/GB05/50062

§ 371 Date: Mar. 31, 2007

(30) Foreign Application Priority Data
May 11, 2004 (GB) 0410388.3

(51) Int. Cl. C08J 5/00

(52) U.S. Cl. 523/124; 264/185

(57) ABSTRACT

A polymer film is made by mixing pellets of starch and of PVA together, and then thermoplastically extruding the mixture. The mixture should contain at least 10% and preferably at least 25% (by weight) of each polymer, and extrusion generates a homogeneous film which appears uniform. It can be as thin as 20 μm. The resulting film is readily biodegradable, water-soluble or water-dispersible, and has good physical properties. This same pellet mixing extrusion process, followed by injection moulding, can be used to form other objects.

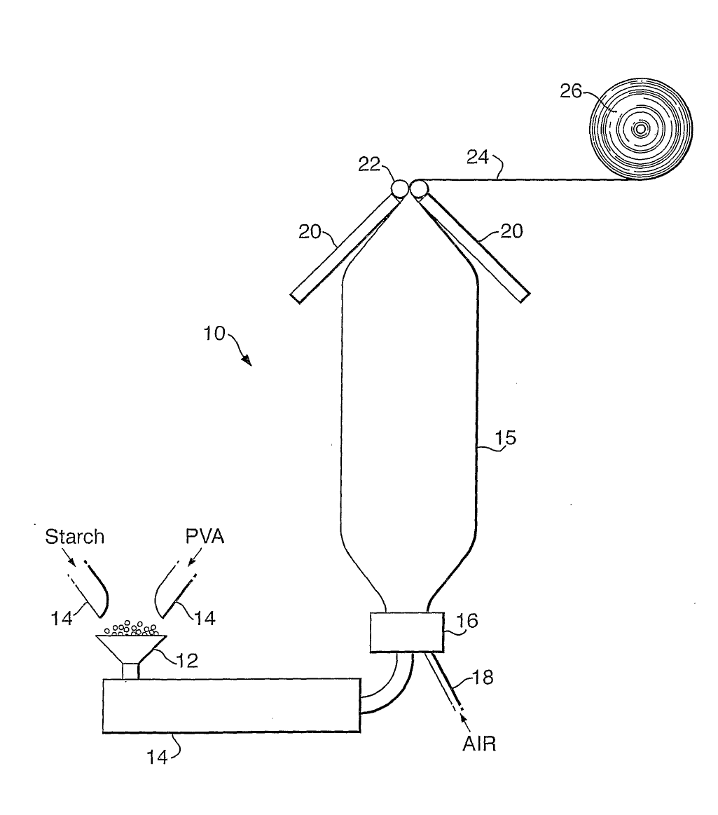

This invention relates to an extrusion process for making a polymeric object, and to an object so made; in particular it provides a way of making a polymer film.

A wide variety of different polymers are available commercially in the form of pellets. Such pellets can be extruded thermoplastically to form films, and two different techniques are known: the first is referred to as cast extrusion, and the other is blown film extrusion. For example, pellets of PVA (poly vinyl alcohol) can be used to form films of thickness in the range 120-20 μm using blown film extrusion through an annular die. However this is a more expensive polymer than, for example, polyethylene. Starch is also available as pellets, and can be extruded by cast extrusion, making films of thickness down to about 120 μm. Such films are adequate for some purposes, but it has not been found to be possible to form thinner films because starch is not strong enough, and is not sufficiently elastic, being too brittle and too sticky to form thinner films.

According to the present invention there is provided a method of forming a polymeric extrusion or moulding wherein pellets of thermoplastically extrudable starch and pellets of thermoplastically extrudable PVA are mixed and then extruded at a temperature in the range 160° C. to 190° C. to form the extrusion or moulding.

The object may be a film or tube produced by blown film extrusion, or alternatively it may be an object formed by injection moulding. The method enables a desired product to be formed that combines starch and PVA, without first requiring the production of mixed pellets.

In a second aspect, the present invention provides a polymer object or a film primarily consisting of starch and PVA, made by the above process.

Preferably the resulting polymer comprises at least 10% but more preferably at least 25% of starch, and at least 10%, preferably at least 20%, and more preferably at least 25% of PVA (by weight). For example it might comprise equal proportions of starch and PVA, or up to 75% of one component. The composition may also include a plasticiser. For example, the pellets of starch may contain a plasticiser; and/or the pellets of PVA may contain a plasticiser. Preferably the pellets of starch and the pellets of PVA are of substantially the same size, most preferably being of the same dimensions to within about 25%. For example the pellets of starch and the pellets of PVA may each be in the form of squat cylinders of diameter 3 mm and of length 3 mm.

Although starch and PVA are chemically unrelated, and are significantly different in their physical properties, it has surprisingly been found that they form a homogeneous film which appears uniform. (This may be contrasted with the result of extruding a mixture of PVA and polyethylene, which produces an inhomogeneous film which is stringy and web-like.) The film of the invention can be blown to thicknesses down to as thin as 20 μm without loss of uniformity. Desirably the starch and the PVA have substantially the same melt flow index, the range of values of melt flow index differing by no more than about 50%, preferably no more than 25%. The extrusion process preferably utilises a single screw extruder.

Furthermore the resulting film is considerably more readily biodegradable than PVA (which is not biodegradable until dissolved), and it will biodegrade in a composting process. The starch itself is preferably water-soluble, although the composting process only requires humidity for growth of the microorganisms that bring about biodegradation. The resulting film also has the advantage of being considerably cheaper than PVA alone.

Pellets of starch and of PVA are melt blended in a single screw extruder to form a homogenous blend, and then extruded. Clearly the pellets may be mixed before being fed into the extruder, or may be fed separately into the extruder and mixed in it. It is consequently very straightforward to adjust the proportions of the two components, PVA and starch, by merely adjusting the numbers of pellets of each. The term “melt” as used herein includes, but is not limited to, merely softening the polymers sufficiently for extrusion. The melting point of starch is about 120-130° C. and that of PVA is about 180-220° C., depending on grade; the extrusion process preferably is carried out at temperatures in the range about 160° to 185° C. (depending on the grade of PVA), that is to say at temperatures above the melting point of starch but below that of the PVA.

Blown film extrusion is well known as a process for making plastic bags and plastic sheets. Typically, a tube of molten plastic is extruded from an annular die, and then stretched and expanded to a larger diameter and a reduced radial thickness by internal air pressure and tension from rollers. The hot tube is cooled by ambient air. Ambient air is also used to provide the internal air pressure within the tube, and so to control the size and thickness of the film tube. There may thus be a flow of air over only the external surface, or over both the external and internal surfaces of the tube in order to obtain the required degree of cooling. Careful control of the air pressure within the tube enables the final diameter of the tube to be controlled, as well as the film thickness.

The term “starch” in this specification refers to carbohydrates of natural, vegetable origin, composed mainly of amylose and/or amylopectin. A variety of plants may be used as a source of starch, for example potatoes, corn or tapioca. Preferably the thermoplastic starch is one that has been prepared using substantially dry starch, with no more than about 5% moisture, processed with a swelling agent or plasticiser such as glycerol or sorbitol in an extrusion process at an elevated temperature (for example between 120° and 220° C.) so that the starch is melted. The resulting thermoplastic starch is substantially free of crystalline fractions, and its properties do not significantly change on storage. A suitable material is manufactured for example by Biotec Biologische Naturverpackungen GmbH & Co KG, and the preparation method is described in U.S. Pat. No. 6,472,497. It will be appreciated that the starch pellets will therefore typically contain a plasticiser, and may contain other biodegradable polymers; the process has not been found to work when using starch pellets that also contain poly lactic acid.

The invention will now be further and more particularly described, by way of example only, and with reference to the accompanying drawing, which shows diagrammatically a side view of a blown film extrusion apparatus.

Referring now to the drawing, a conventional blown film extrusion apparatus 10 incorporates a hopper 12 to which pellets of thermoplastic starch (for example Bioplast TPS) and pellets of PVA are supplied through chutes 13. The pellets are typically of diameter in the range 2-3 mm and of length in the range 2-4 mm. By way of example the pellets of each component preferably have a melt flow index (at 210° C. and a load of 2.16 kg) in the range 0.45 to 1.6 g/10 min. The mixture of pellets in the hopper 12 is fed into a single-screw extruder 14 which mixes and heats the polymers, and the resulting molten mixture is supplied to an annular die 16. It emerges as a polymer tube 15. Compressed air is fed into the inside of the tube from a duct 18, so the tube 15 increases in diameter, typically the diameter increase being in the range 2.5 to 4.5 times. As the tube 15 cools, its physical dimensions become set (at what may be referred to as the “frost point”). The tube 15 is then guided by angled guides 20 to a pair of nip rollers 22 which flatten the tube so as to form two flat films 24; the nip rollers 22 pull the tube 15 at a faster rate than it is extruded through the die 16, so the tube 15 is stretched longitudinally (as well as being stretched transversely by the air pressure). The films 24 can then be fed onto a storage roller 26. Such apparatus 10 is known, and for example is described in U.S. Pat. No. 3,959,425 and in U.S. Pat. No. 4,820,471, at least as regards forming films from polyethylene.

The present invention thus enables biodegradable, water-soluble or water-dispersible films to be made at a relatively low cost, and with good physical properties. This is evident from the measured properties of the resulting films as shown in table 1, in which measurements made on a conventional PVA film are compared to those made from a mixture of PVA and starch containing 50% of each component; in this case the PVA is a grade which would be soluble in cold water at say 10° C. The two films of the invention were of nominal thicknesses 25 and 75 μm. The mechanical properties (of dry film) are tabulated in both the machine direction (MD), which is the longitudinal direction of the extrusion, and in the transverse direction (TD). The disintegration and dissolution times are the times taken for the films to disintegrate or dissolve in water at 10° C.

TABLE 1

| | PVA | PVA/starch | PVA/starch |
|---|---|---|---|
| Gauge/μm | 30.0 | 23.9 | 69.0 |
| Maximum stress (MD)/MPa | 50 | 14.61 | 14.80 |
| Maximum stress (TD)/MPa | 35 | 13.10 | 14.27 |
| Extension at break (MD)/% | 200 | 307 | 363 |
| Extension at break (TD)/% | 350 | 308 | 363 |
| Elastic modulus (MD)/MPa | 30 | 4.4 | 3.4 |
| Elastic modulus (TD)/MPa | 5 | 3.6 | 3.3 |
| Disintegration time/s | 10 | 1 | 14 |
| Dissolution time/s | 45 | 128 | 420 |

Referring now to table 2, measurements are shown for films of a conventional PVA film and those made from mixtures of PVA and starch; in this case the PVA is a grade which would be soluble in warm water at say 60° C. It should be noted that the films of the invention were of different thicknesses. The mechanical properties (of dry film) are tabulated in both the machine direction (MD), which is the longitudinal direction of the extrusion, and in the transverse direction (TD). The disintegration and dissolution times are the times taken for the films to disintegrate or dissolve in water at 63° C.

TABLE 2

| | | PVA/50% | PVA/25% | PVA/33% |
|---|---|---|---|---|
| | PVA | starch | starch | starch |
| Gauge/μm | 25.6 | 18.9 | 50.8 | 24.9 |
| Maximum stress | 74.40 | 30.96 | 40.00 | 44.35 |
| (MD)/MPa | | | | |
| Maximum stress | 50.60 | 29.60 | 35.73 | 46.92 |
| (TD)/MPa | | | | |
| Extension at break | 169 | 130 | 222 | 166 |
| (MD)/% | | | | |
| Extension at break | 304 | 219 | 274 | 261 |
| (TD)/% | | | | |
| Elastic Modulus | 121 | 50 | 50 | 61 |
| (MD)/MPa | | | | |
| Elastic modulus | 49 | 22 | 32 | 27 |
| (TD)/MPa | | | | |
| Disintegration time/s | 1.33 | 1 | 2.66 | 2 |
| Dissolution time/s | 38.7 | 127 | 302 | 152 |

1. A method of forming a polymeric extrusion or moulding wherein pellets of thermoplastically extrudable starch and pellets of thermoplastically extrudable PVA are mixed and then extruded at a temperature in the range 160° C. to 190° C. to form the extrusion or moulding, and wherein the thermoplastic starch is one that has been prepared using substantially dry starch, with no more than about 5% moisture, processed at an elevated temperature with a swelling agent or plasticiser such as glycerol or sorbitol in an extrusion process so that the starch is melted.

2. A method as claimed in claim 1 wherein the said pellets are mixed and extruded, using a single screw extruder.

3. A method as claimed in claim 1 wherein the proportions of starch and PVA that are mixed are at least 10% of starch and at least 10% of PVA by weight.

4. A method as claimed in claim 1 wherein the pellets of starch and the pellets of PVA are of substantially the same size, most preferably being of the same dimensions to within about 25%.

5. A polymeric moulding consisting primarily of thermoplastic starch and PVA, and formed by a method as claimed in claim 1, and which is formed by injection moulding.

6. A polymeric extrusion consisting primarily of thermoplastic starch and PVA, and formed by a method as claimed in claim 1.

7. A polymeric extrusion as claimed in claim 6 which is a film.

8. A film as claimed in claim 7 which is less than 50 μm thick.

9. A method of forming a polymeric extrusion or moulding wherein pellets of thermoplastically extrudable starch and pellets of thermoplastically extrudable PVA are mixed and then extruded at a temperature in the range 160° C. to 190° C. to form the extrusion or moulding, and wherein the thermoplastic starch is one that has been prepared using substantially dry starch, with no more than about 5% moisture, processed at an elevated temperature with a swelling agent or plasticiser such as glycerol or sorbitol in an extrusion process so that the starch is melted, said pellets are mixed and extruded, using a single screw extruder, the proportions of starch and PVA that are mixed are at least 10% of starch and at least 10% of PVA by weight.

10. A method as claimed in claim 9 wherein the pellets of starch and the pellets of PVA are of substantially the same size, most preferably being of the same dimensions to within about 25%.

11. A polymeric moulding consisting primarily of thermoplastic starch and PVA, and formed by a method as claimed in claim 10, and which is formed by injection moulding

12. A polymeric extrusion as claimed in claim 11 which is a film.

13. A film as claimed in claim 12 which is less than 50 μm thick.
